(19) United States
(12) Patent Application Publication
(10) Pub. No.: US 2010/0332415 A1
(43) Pub. Date: Dec. 30, 2010

(54) STAMP PRINTER FOR PRINTING POSTAGE STAMPS RELATED TO AN ITEM IN A MAIL PIECE ON DEMAND

(75) Inventor: Mark E. Sievel, Newton, CT (US)

Correspondence Address: PITNEY BOWES INC.;INTELLECTUAL PROPERTY & TECH. LAW DEPT., 35 WATERVIEW DRIVE, MSC 26-22, SHELTON, CT, 06484, US

(73) Assignee: Pitney Bowes Inc., Stamford, CT (US)

(21) Appl. No.: 12/492,199

(22) Filed: Jun. 26, 2009

(51) Int. Cl. G07B 17/02; G06F 17/30; B41F 33/00

(52) U.S. Cl. 705/408; 101/483; 707/769; 707/759

(57) ABSTRACT

A stamp printer includes a memory device that stores a library of available images approved for use as a postage stamp. A code that identifies the item that will be included in the mail piece is input to the stamp printer. Using the information obtained from the code, the stamp printer identifies the item and searches the library of postage stamp images to identify those images that are related in some way to the specific item. The stamp printer can then display the identified postage stamp images to the user and allow the user to make a selection. Upon receiving a selection from the user, the stamp printer can then print the postage stamp selected by the user.

### FIELD OF THE INVENTION

The invention disclosed herein relates generally to postage printing systems, and more particularly to a stamp printing device that prints postage stamps on demand.

### BACKGROUND OF THE INVENTION

It is a common practice throughout the world to use postage stamps as an indication that postage has been paid for the delivery of a mail piece, which can include letters, packages, and the like. These postage stamps are typically produced and issued by a government agency and procured for use by the general public. The postage stamps can either be obtained at a local post office, or procured out of a postal vending machine (either pre-printed stamp vending or print on demand stamp vending). Moreover, for certain holidays, occasions, or special events, e.g., religious holidays, birthdays, weddings, and the like, the postal authority often produces special edition or commemorative stamps that specifically relate to such holidays, occasions, or special events and add a personal touch to the mail piece. However, if the sender of the mail piece is unaware that these stamps exist, the sender will not be able to utilize such stamps.

### SUMMARY OF THE INVENTION

The present invention provides a stamp printer that provides a user with a selection of appropriate postage stamps related to the mail piece that the user is sending.

In accordance with embodiments of the present invention, a stamp printer includes a memory device that stores a library of available images approved for use as a postage stamp. A code that identifies the item that will be included in the mail piece, such as, for example, the Universal Product Code (UPC) barcode, is input to the stamp printer using, for example, a scanning device or keyboard. Using the information obtained from the code, the stamp printer identifies the item and searches the library of postage stamp images to identify those images that are related in some way to the specific item. The stamp printer can then display the identified postage stamp images to the user and allow the user to make a selection. Upon receiving a selection from the user, the stamp printer can then print the postage stamp selected by the user. Additionally, the information obtained from the code can be used to determine the amount of postage required based on the item to be included in the mail piece.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a portion of a stamp printer for printing postage stamps according to an embodiment of the present invention; and

FIG. 2 illustrates in flow diagram form the operation of the stamp printer of FIG. 1 according to an embodiment of the present invention.

### DETAILED DESCRIPTION OF THE PRESENT INVENTION

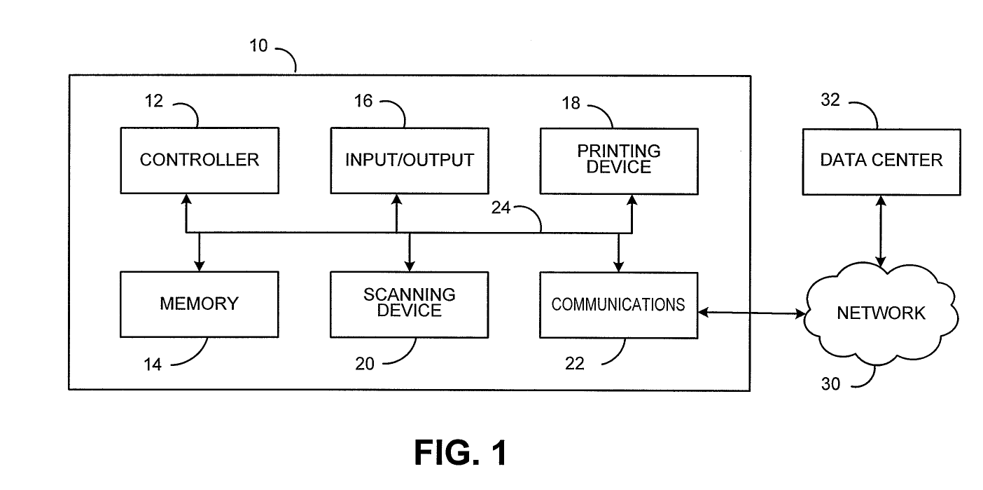

In describing the present invention, reference is made to the drawings, wherein there is seen in FIG. 1 a portion of a stamp printer 10 according to an embodiment of the present invention. Stamp printer 10 is preferably a self service device, i.e., usable by the customer without any help from a store clerk, that is located in a retail environment where customers will purchase items that may be sent to a desired recipient in a physical mail piece. As referred to herein, a physical mail piece includes any type of letter, parcel or package that can be delivered by a carrier to a designated recipient. Such items that can be sent in a mail piece can include, for example, greeting cards, invitations, and items intended to be gifts for special occasions (birthdays, etc). Stamp printer 10 may be included, for example, as part of a kiosk. Stamp printer 10 includes a control unit, referred to herein as controller 12, that preferably includes one or more processor units, such as, for example, a microprocessor, general or special purpose processor or the like, to control operation of the stamp printer 10. A memory device 14 provides storage for information utilized by the controller 12 as well as programs for execution by the controller 12. An input/output (I/O) device 16, such as, for example a display (which may be a touch screen display), keyboard, speaker, or the like, is provided to provide information to and receive information from a user. A printing device 18, which may be, for example, a digital printing device such as a bubble jet or ink jet printing device, is used to print postage stamps dispensed by the stamp printer 10. Printing device 18 is preferably a color printer to print images in multiple colors. A scanning device 20 may be provided to read printed barcodes as described below. Scanning device 20 can be any suitable camera or optical scanner, as are known, capable of reading a barcode. Scanning device 20 can be integral with the stamp printer 10, or may be a separate device, such as a hand-held device, e.g., a cell phone or the like, that is coupled to the stamp printer 10 using a wired link, e.g., USB cable, or wireless link, e.g., IR link. A communications device 22, e.g., modem, network card, or the like, is provided to allow the stamp printer 10 to communicate with a data center 32 via a network 30, such as the Internet or other network, for postage funds refill, software downloads, rates downloads, market-oriented data capture, kiosk management and the like. Communication between the various internal components of the stamp printer 10 is provided by a communication line 24, which may be, for example, a bus or the like.

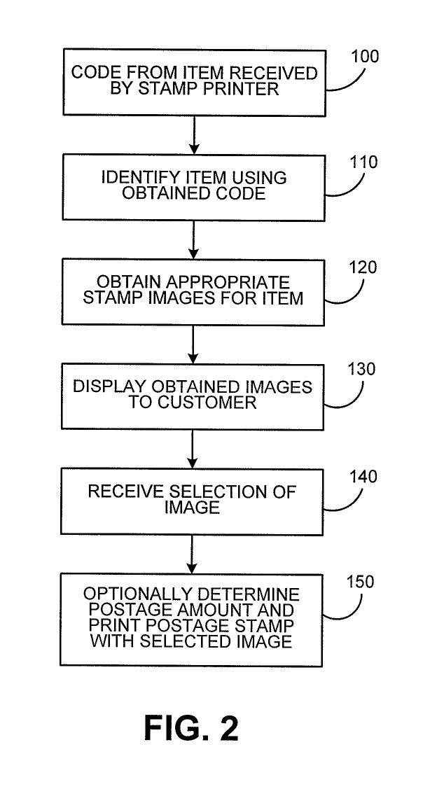

FIG. 2 illustrates in flow diagram form the operation of the stamp printer 10 according to an embodiment of the invention. Operation of the stamp printer 12 is controlled by the controller 12 executing one or more programs that may be stored in the memory 14 in response to inputs provided by a user. When a user (also referred to as customer) selects an item to be included in a mail piece, the customer takes the item to the self service stamp printer 10. At step 100, a code that is provided on the item that at least partially identifies the item is input to the stamp printer 10. The code could be, for example, the UPC barcode or other code placed on the item by the manufacturer of the item that provides an identification of the item. Preferably, the code is provided in machine readable format, e.g., a barcode or the like, and in human readable format. Inputting of the code to the stamp printer 10 may be done, for example, by scanning the code using the scanning device 20 of the stamp printer 10, or alternatively a hand-held device that can be communicatively coupled to the stamp printer 10. Alternatively, the code could be entered manually, using, for example, the I/O device 16. At step 110, the controller 12 will use the obtained code to identify the item. This can be performed, for example, using the information provided in the code (if sufficient to accurately identify the item), or if necessary, accessing a database which may be stored in the memory 14 or remotely at data center 32 and accessed via the network 30. Thus, for example, if the item is a greeting card, but the information included in the code is not detailed enough to determine the exact type of greeting card, e.g., birthday, wedding, get well, invitations, etc., a database can be accessed and the code used as a pointer to access stored information that provides sufficient detail with respect to an identification of the item. The stored information could include, for example, the exact type of greeting card, invitations, or stationary based on occasion, the size of the greeting card, the designs included on the card or stationary, a type of toy, a character, etc.

In step 120, the controller 12, using the information obtained about the item to be sent by the customer in step 110, obtains appropriate stamp images that are related to the item. These images can be stored in the memory 14 of the stamp printer 10 (and updated from time to time by communications with the remote data center 32), or can be obtained from a database located at the remote data center 32 using the communications device 22 and network 30. Thus for example, if the item is a birthday card, stamp images related to birthdays will be obtained by the controller 12. If the item is a birthday card that has a design of a specific cartoon character on it, the controller 12 can also obtain stamp images that include that specific cartoon character, if available. If the item is a stuffed animal, the controller 12 can obtain stamp images that include that type of animal, if available. If the item is a toy, the controller 12 can obtain stamp images related to that type of toy, if available. In step 130, the controller 12 will display the obtained stamp images to the customer using the display of the I/O device 16. Alternatively, if the stamp printer 10 is coupled to another device that has a display, such as, for example, a point of sale terminal that includes a display, the obtained stamp images could be displayed on the display of the other device. Depending upon the number of stamp images obtained, it may be necessary for multiple screens to be displayed to the customer, and allow the customer to move between the different screens to view all of the images. Thus, the customer can then review the available images that are related in some way, e.g., similar occasion, similar design, etc., to the item to be mailed. Since the stamp printer 10 automatically selects appropriate stamp images and displays them to the customer, the customer is not required to sift through multiple screens of all available images to find only appropriate images from the full library of available images.

Once the customer has decided on the stamp image to be included on the mail piece for mailing the item, in step 140 the customer will enter the selection, preferably using the I/O device 16 of the stamp printer 10. Alternatively, the customer can make a selection using a hand-held device that can transmit the selection to the stamp printer 10. Upon receiving the selected stamp image, then in step 150 the controller 12 will cause the printing device 18 to print a postage stamp using the image selected by the customer. Such printing can either be directly on the mail piece, e.g., the envelope, or on a label to be affixed to the mail piece.

Additionally, as an option in step 150 before the postage stamp is printed, the controller 12 can utilize the information obtained from the code in step 100 to determine the amount of postage to be included in the stamp. For example, the information about the item obtained by the controller 12 could indicate that additional postage is required to send the item. In the case of a card, for example, the information could indicate that the card is oversized, or has an irregular shape, or is overweight, each of which would require additional postage for the card to be delivered. Using this information, the controller 12 can determine the correct postage amount required to deliver the item, and print a postage stamp, using the image selected by the customer, that has the correct postage amount included therein.

Thus, the stamp printer 10 according to the present invention includes several advantageous features with respect to selecting an image to be included on a postage stamp printed by the stamp printer 10. The stamp printer 10 enables a customer to easily identify appropriate images that are related some way, e.g., similar occasion, similar design, etc., to the item to be mailed. Since the stamp printer 10 automatically selects appropriate stamp images and displays them to the customer, the customer is not required to sift through multiple screens of all available images to find only appropriate images from the full library of available images. While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

I claim:

1. A method for a stamp printing device to print a postage stamp for a mail piece, the method comprising:
receiving a code from an item to be included in the mail piece to obtain information about the item;
obtaining stamp images that are related to the item based on the information obtained about the item from the code;
displaying the obtained stamp images related to the item;
receiving an indication of a selected stamp image from the displayed stamp images; and
printing the postage stamp, using a printer of the stamp printing device, having the selected image.

2. The method of claim 1, further comprising:
determining an amount of postage for the postage stamp based on the information obtained about the item from the code.

3. The method of claim 1, wherein obtaining stamp images further comprises:
obtaining stamp images stored in a memory device of the stamp printing device.

4. The method of claim 1, wherein obtaining stamp images further comprises:
obtaining stamp images stored in database remote from the stamp printing device.

5. The method of claim 1, wherein receiving the code to obtain information about the item further comprises:
identifying the item based on information included in the code from the item.

6. The method of claim 1, wherein receiving the code to obtain information about the item further comprises:
accessing a database remote from the stamp printing device to identify the item based on the code from the item.

7. The method of claim 1, wherein receiving the code to obtain information about the item further comprises:
accessing a database in a memory device of the stamp printing device to identify the item based on the code from the item.

8. The method of claim 1, wherein the code is a barcode, and receiving a code from an item further comprises:
reading the barcode using a scanning device to obtain information about the item.

9. The method of claim 8, wherein the barcode is part of a universal product code provided on the item.

10. The method of claim 1, wherein receiving the code to obtain information about the item further comprises:
receiving the code via a manual input device.

11. A stamp printing device comprising:
a control unit to control operation of the stamp printing device;
a printer coupled to the control unit for printing images;
an input device coupled to the control unit to input a code provided on an item to be included in a mail piece;
a display device coupled to the control unit; and
the control unit being programmed to obtain information about the item based on the code input from the input device, obtain stamp images that are related to the item based on the information obtained about the item from the code, display, using the display device, the obtained stamp images related to the item, and cause the printer to print a postage stamp having a stamp image selected from the displayed stamp images.

12. The stamp printing device of claim 11, wherein the control unit is further programmed to determine an amount of postage for the postage stamp based on the information obtained about the item from the barcode.

13. The stamp printing device of claim 11, further comprising:
a memory device coupled to the control unit to store stamp images.

14. The stamp printing device of claim 11, further comprising:
a communication device coupled to the control unit,
wherein the control unit obtains stamp images from a remote database using the communication device.

15. The stamp printing device of claim 11, wherein the input device includes a scanning device that is used to scan the code on the item.

16. The stamp printing device of claim 11, wherein the code is part of a universal product code provided on the item.
